(19) United States
(12) Patent Application Publication
(10) Pub. No.: US 2002/0057913 A1
(43) Pub. Date: May 16, 2002

(54) Printer used in combination with image sending apparatus and printer adapter attachable/detachable to/from the printer

(76) Inventor: Koichi Katsura, Kanagawa (JP)

Correspondence Address: MORGAN & FINNEGAN, L.L.P., 345 PARK AVENUE, NEW YORK, NY, 10154, US

(21) Appl. No.: 09/951,304

(22) Filed: Sep. 11, 2001

(30) Foreign Application Priority Data
Sep. 11, 2000 (JP) 2000-276726

(51) Int. Cl. G03B 17/48

(52) U.S. Cl. 396/429

(57) ABSTRACT

To provide a printer built-in camera with improved usability, a printer used in combination with an image sensing apparatus has a printing unit which prints an image obtained by the image sensing apparatus on a print sheet, and a storage unit connected to the printing unit, in which an unused print sheet supplied to the printing unit and printed sheets printed by the printing unit are stored.

### FIELD OF THE INVENTION

The present invention relates to a printer used in combination with an image sensing apparatus and a printer adapter attachable/detachable the printer.

### BACKGROUND OF THE INVENTION

Conventionally, there has been a need of users to obtain a photographic print output on the spot of image sensing. To meet this requirement, apparatuses to obtain print outputs in a short period after image sensing by using so-called instant camera and instant film have been proposed (apparatuses disclosed in U.S. Pat. Nos. 3,709,122, 3,727,529, 4,000,500, 4,249,811 and 4,212,524, a film cartridge disclosed in U.S. Pat. No. 3,707,116, and the like).

However, the above conventional apparatuses have the following problems.

1) An image obtained by image sensing is merely recorded on an instant film, and if plural print outputs are required, the image formed on the instant film is duplicated. In comparison with silver chloride film, the storage method of original image or the like is inconvenient.

2) It is not necessary to print out all the scenes. However, in the case of instant photography, it is not impossible to print out the images later instead of printing them on the spot.

To compensate for these drawbacks of instant photography, proposed is a camera which inputs image information obtained by electronic image sensing means such as a solid image sensing device into a memory so as to print-output the information arbitrarily.

Generally, printer apparatuses especially for print-outputting color image information are 1) a melting thermal transfer printer, 2) a sublimation type thermal transfer printer, 3) an ink-jet printer and the like. Above all, the ink-jet printer, with a low running cost, is superior in downsizing, reduction of electric consumption, output speed and the like, and is very effective for use in a camera requiring a portability.

As examples of the above-described printer built-in camera, U.S. Pat. No. 4,074,324 and Japanese Published Unexamined Patent Application No. Sho 54-136325 disclose a printer built-in camera to print-output information electrically obtained by a solid image sensing device or the like, and Japanese Published Unexamined Patent Application No. Hei 4-200181 discloses a printer built-in camera corresponding to plural types of ink ribbons and plural types of print sheets.

However, the above-described printer built-in cameras are not sufficiently useful consumer products in the new genre of combination camera/printer apparatus. That is, in the conventional printer built-in camera, when an image is to be printed while a user is on the road, as the user has to store the printed sheet, the usability cannot be improved.

### SUMMARY OF THE INVENTION

The present invention has been made in consideration of the above-described problems, and has its object to provide a printer and a printer adapter with improved usability.

According to the first aspect of the present invention, to solve the above problems and attain the foregoing object, a printer of the present invention has the following construction.

That is, provided is a printer used in combination with an image sensing apparatus including: a printing unit that prints an image obtained by the image sensing apparatus on a print sheet; and a storage unit, connected to the printing unit, that holds an unused print sheet supplied to the printing unit and a printed sheet printed by the printing unit.

Further, according to the second aspect of the present invention, the printer of the present invention has the following construction.

That is, provided is a printer including: a printing unit that performs printing on a print sheet; and a storage unit, connected to the printing unit, that holds unused print sheets supplied to the printing unit and printed sheets printed by the printing unit.

Further, according to the third aspect of the present invention, a printer adapter of the present invention has the following construction.

That is, provided is a printer adapter attachable/detachable to/from a printer which is used in combination with an image sensing apparatus and which prints an image obtained by the image sensing apparatus on a print sheet, wherein the adapter including: a storage unit that holds unused print sheets supplied to the printer and printed sheets printed by the printer.

Further, according to the fourth aspect of the present invention, the printer adapter of the present invention has the following construction.

That is, provided is a printer adapter attachable/detachable to/from a printer which performs printing on a print sheet including: a storage unit that holds unused print sheets supplied to the printer and printed sheets printed by the printer.

Other objects and advantages besides those discussed above shall be apparent to those skilled in the art from the description of a preferred embodiment of the invention which follows. In the description, reference is made to accompanying drawings, which form a part thereof, and which illustrate an example of the invention. Such example, however, is not exhaustive of the various embodiments of the invention, and therefore reference is made to the claims which follow the description for determining the scope of the invention.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a perspective view of a printer built-in camera according to a first embodiment of the present invention;

FIG. 2 is a perspective view of a print sheet storage unit attachable/detachable to/from the printer built-in camera in FIG. 1;

FIG. 3 is a perspective view of the printer built-in camera in FIG. 1 to which the print sheet storage unit in FIG. 2 is attached;

FIG. 4 is a cross-sectional view along a line IV-IV in FIG. 2;

FIG. 5 is a cross-sectional view of the printer built-in camera according to a second embodiment of the present invention;

FIG. 6 is a perspective view of the print sheet storage unit attachable/detachable to/from the printer built-in camera in FIG. 5;

FIG. 7 is a perspective view of the printer built-in camera in FIG. 5 to which the print sheet storage unit in FIG. 6 is attached;

FIG. 8 is a cross-sectional view along a line VIII-VIII in FIG. 6;

FIG. 9 is a cross-sectional view of the printer built-in camera according to a third embodiment of the present invention;

FIG. 10 is a cross-sectional view of the print sheet storage unit attachable/detachable to/from the printer built-in camera in FIG. 9;

FIG. 11 is a block diagram showing the construction of the printer built-in camera according to the third embodiment; and

FIG. 12 is a flowchart showing printed sheet storing processing.

### DETAILED DESCRIPTION OF THE PREFERRED EMBODIMENTS

Preferred embodiments of the present invention will now be described in detail in accordance with the accompanying drawings.

<First Embodiment>

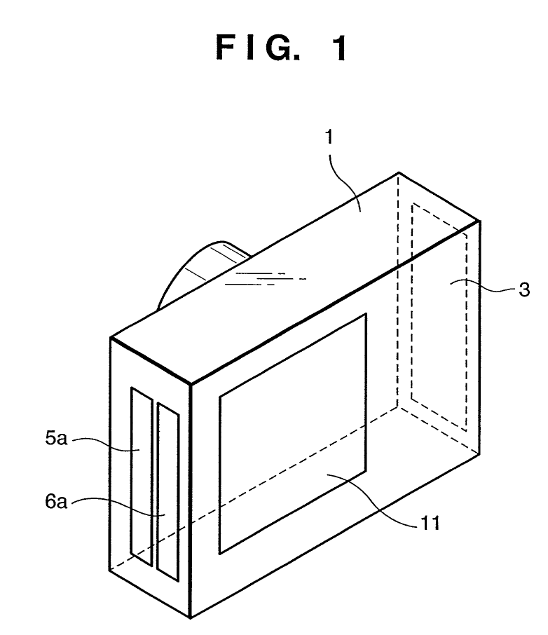

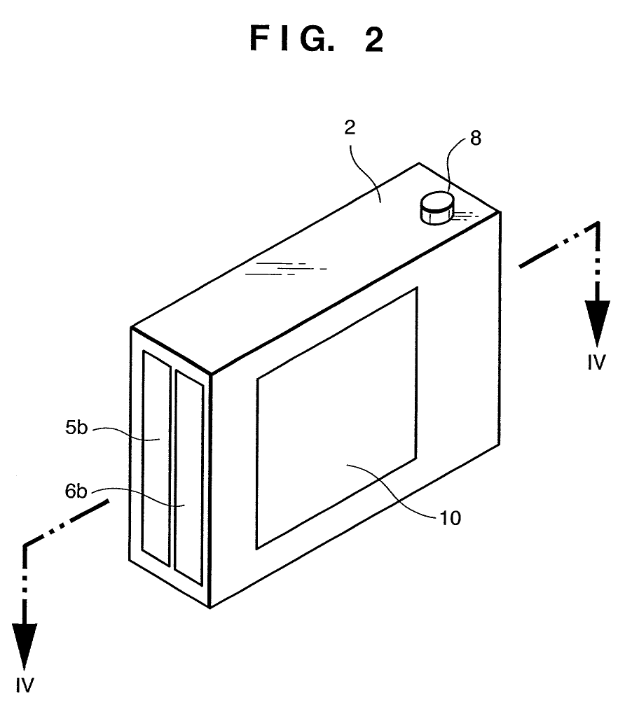

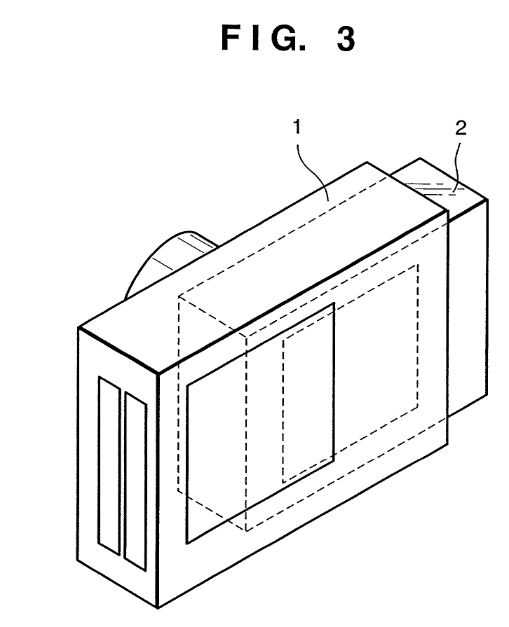

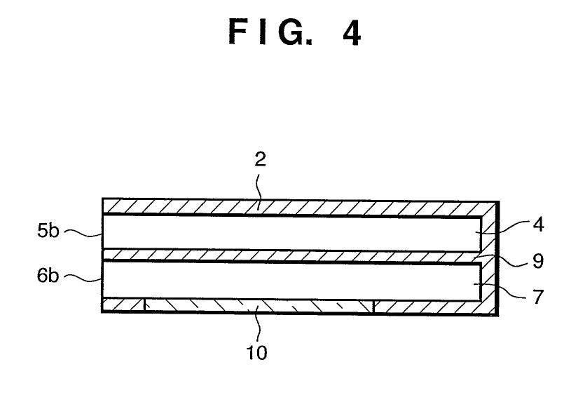

FIG. 1 is a perspective view of a printer built-in camera according to a first embodiment of the present invention. FIG. 2 is a perspective view of a print sheet storage unit attachable/detachable to/from the printer built-in camera in FIG. 1. FIG. 3 is a perspective view of the printer built-in camera in FIG. 1 to which the print sheet storage unit in FIG. 2 is attached. FIG. 4 is a cross-sectional view along a line IV-IV in FIG. 2.

As shown in FIG. 1, in the printer built-in camera according to the first embodiment of the present invention, a camera main body 1 has an opening 3 into which a removable print sheet storage unit 2 (print sheet storage means) is inserted, a discharge portion 5a from which a printed sheet is discharged, an opening 6a through which the printed sheet is stored in the print sheet storage unit 2, and an open window 11 through which the print sheet stored in the print sheet storage unit 2 is checked. Further, the camera main body 1 has a printer (not shown) which discharges ink from the photographer side toward the subject side.

As shown in FIG. 2, the print sheet storage unit 2 has a discharge portion 5b from which a printed sheet is discharged, an opening 6b through which the printed sheet is stored, an operation unit 8 (take out means) for taking out the temporarily stored print sheet, and an open window 10 through which the stored print sheet is checked. Further, as shown in FIG. 4, the print sheet storage unit 2 has an unused sheet storage unit 4 provided on the subject side in the print sheet storage unit 2, in which unused print sheets are stored, and a printed sheet storage unit 7 provided on the photographer (hereinbelow referred to as a “user”) side in the print sheet storage unit 2, in which printed sheets are stored. An inner wall 9 is provided between the unused sheet storage unit 4 and the printed sheet storage unit 7. The inner wall 9 prevents mixing of printed sheets into the unused sheets storage unit 4, thus prevents the user's unexpected overlapped printing.

Upon printing, the user inserts the print sheet storage unit 2 into the camera main body 1 as shown in FIG. 3 and uses the camera main body 1. When the user only performs image sensing without printing, the user can use only the camera main body 1. Accordingly, when only image sensing is performed, the entire camera can be downsized.

Further, when the print sheet storage unit 2 is inserted into the camera main body 1, the user can check a printed sheet in the forefront of the open windows 10 and 11 through the open windows. Further, even when the print sheet storage unit 2 is removed from the camera main body 1, the user can check, through the open window 10 of the print sheet storage unit 2, the printed sheet in the forefront of the open window. Further, when the user desires to see the printed sheet, the user can take out the printed sheet any number of times by operating the operation unit 8.

An image obtained by image sensing is print-outputted on a print sheet stored in the unused sheet storage unit 4, then discharged from the discharge portion 5b to the outside the print sheet storage unit, and discharged through the discharge portion 5a of the camera main body 1 to the outside the camera. The user can see the image on the discharged print sheet then store the sheet into the printed sheet storage unit 7 on the photographer side in the print sheet storage unit 2 via the opening 6a of the camera main body 1 and the opening 6b of the print sheet storage unit 2. Thus the printed sheet can be protected from breakage and contamination.

As described above, according to the present embodiment, as the print sheet storage unit 2 holds printed print sheets as well as unused print sheets, the printed sheets can be protected, and the portability of printed sheets can be improved. Thus the usability can be improved.

Note that in the present embodiment, the printer that discharges ink from the user side toward the subject side is used, and the unused sheet storage unit 4 is provided on the subject side and the printed sheet storage unit 7 is provided on the user side, however, it may be arranged such that the unused sheet storage unit 4 is provided on the user side and the printed sheet storage unit 7 is provided on the subject side. In this case, when the print sheet storage unit 2 is inserted into the camera main body 1, the printing status can be checked through the open windows 10 and 11.

<Second Embodiment>

In the printer built-in camera according to a second embodiment of the present invention, a part of elements is different from those of the printer built-in camera of the first embodiment. Hereinbelow, the different elements will be mainly described, and other elements corresponding to those of the first embodiment have the same reference numerals and the explanations of the other elements will be omitted.

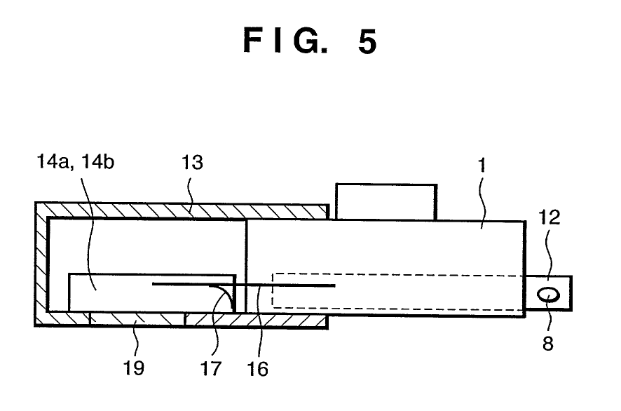

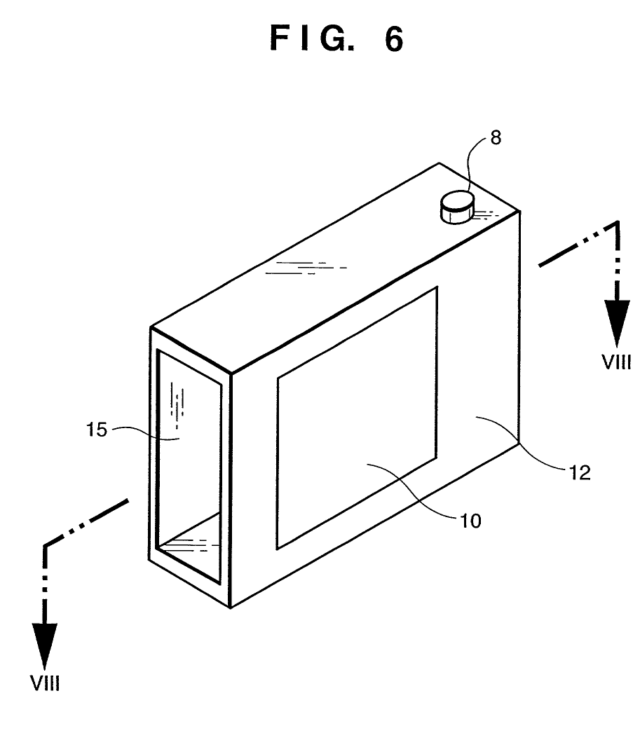

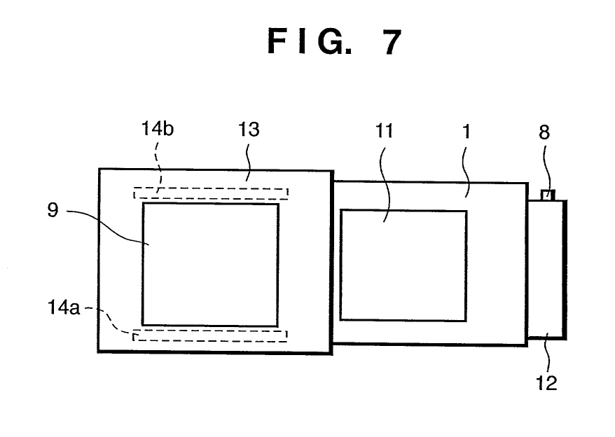

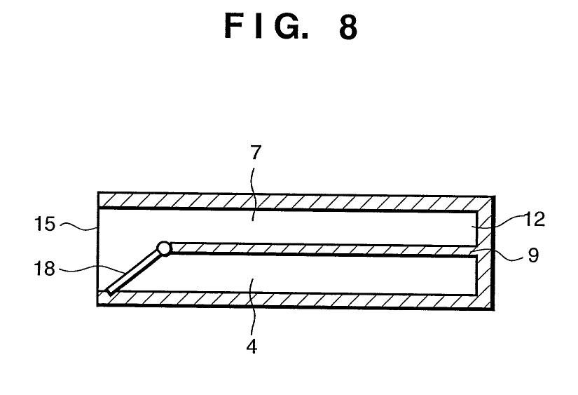

FIG. 5 is a cross-sectional view of the printer built-in camera according to the second embodiment of the present invention. FIG. 6 is a perspective view of the print sheet storage unit attachable/detachable to/from the printer built-in camera in FIG. 5. FIG. 7 is a perspective view of the printer built-in camera in FIG. 5 to which the print sheet storage unit in FIG. 6 is attached. FIG. 8 is a cross-sectional view along a line VIII-VIII in FIG. 6.

As shown in FIG. 5, in the printer built-in camera according to the second embodiment of the present invention, the camera main body 1 has a printer (not shown) which discharges ink from the photographer side toward the subject side and a barrier 13 (image sensing lens storage means) which protects an image sensing lens.

As shown in FIG. 5, the barrier 13 has print sheet holding members 14a and 14b which hold printed sheets, a thrust member 17 which leans the printed sheet temporarily stored in the barrier 13 to the subject side, and an open window 19 through which the printed sheet is checked.

As shown in FIG. 6, a print sheet storage unit 12 inserted into the camera main body 1 has a discharge/storage port 15 through which print sheets are discharged or stored, the operation unit 8 and the open window 10. When the user desires to see printed sheets, the user can take out the printed sheets any number of times by operating the operation unit 8.

Further, as shown in FIG. 8, the print sheet storage unit 12 has the unused sheet storage unit 4 provided on the user side in the print sheet storage unit 12, in which unused print sheets are stored, the printed sheet storage unit 7 provided on the subject side in the print sheet storage unit 12, in which printed sheets are stored, and an introduction switching unit 18 which defines an opening direction of the unused sheet storage unit 4 and the printed sheet storage unit 7. The inner wall 9 is provided between the unused sheet storage unit 4 and the printed sheet storage unit 7. The introduction switching unit 18 prevents storage of printed sheet into the unused sheet storage unit 4.

The introduction switching unit 18 is stressed by an elastic body such as a spring. When a print sheet is sent by a paper feeding unit (not shown) from the unused sheet storage unit 4 in accordance with start of printing, the print sheet itself opens the introduction switching unit 18.

On the other hand, when printed sheets are stored into the printed sheet storage unit 7 in cooperation with a closing operation of the barrier 13, as the printed sheet storage unit 7 is opened, the storage of printed sheet into the unused sheet storage unit 4 can be prevented.

When printing is started, a print sheet 16 (FIG. 5), discharged from the unused sheet storage unit 4 through the discharge/storage port 15, is held by the print sheet holding members 14a and 14b in the barrier 13 thus temporarily stored in the barrier 13. Then, in cooperation with the closing operation of the barrier 13 in a direction to cover the image sensing lens, the print sheet 16 is stored into the printed sheet storage unit 7 via the discharge/storage port 15. The print sheet 16 temporarily stored in the barrier 13 is leaned to the subject side by the thrust member 17. In this manner, the storage into the printed sheet storage unit 7 is performed such that the latest printed sheet 16 is always in the forefront of the subject side.

When the print sheet storage unit 12 is inserted into the camera main body 1, the user can check an image on a printed sheet through the open window 11 and an open window 19 provided in the barrier 13.

As described above, according to the present embodiment, printed sheets can be stored into the printed sheet storage unit 7 in cooperation with the closing operation of the barrier 13, and the storage of printed sheet into the unused sheet storage unit 4 can be prevented.

Note that in the present embodiment, one opening 15 is used in the print sheet storage unit 12 for discharge/storage of print sheet, however, as in the case of the first embodiment, the print sheet storage unit 12 may have two openings (e.g. the discharge portion 5b and the opening 6b).

Further, in the present embodiment, the printer that discharges ink from the user side toward the subject side is used, and the unused sheet storage unit 4 is provided on the user side and the printed sheet storage unit 7 is provided on the subject side, however, it may be arranged such that the unused sheet storage unit 4 is provided on the subject side and the printed sheet storage unit 7 is provided on the user side. In this case, when the print sheet storage unit 12 is inserted into the camera main body 1, the printing status can be checked through the open window 11.

<Third Embodiment>

In the printer built-in camera according to a third embodiment of the present invention, a part of elements is different from those of the first and second embodiments. Hereinbelow, the different elements will be mainly described, and other elements corresponding to those of the first and second embodiments have the same reference numerals and the explanations of the other elements will be omitted.

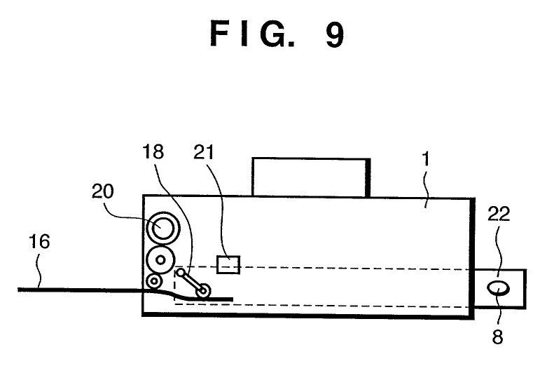

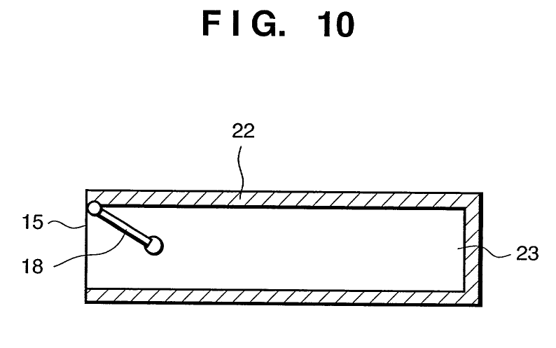

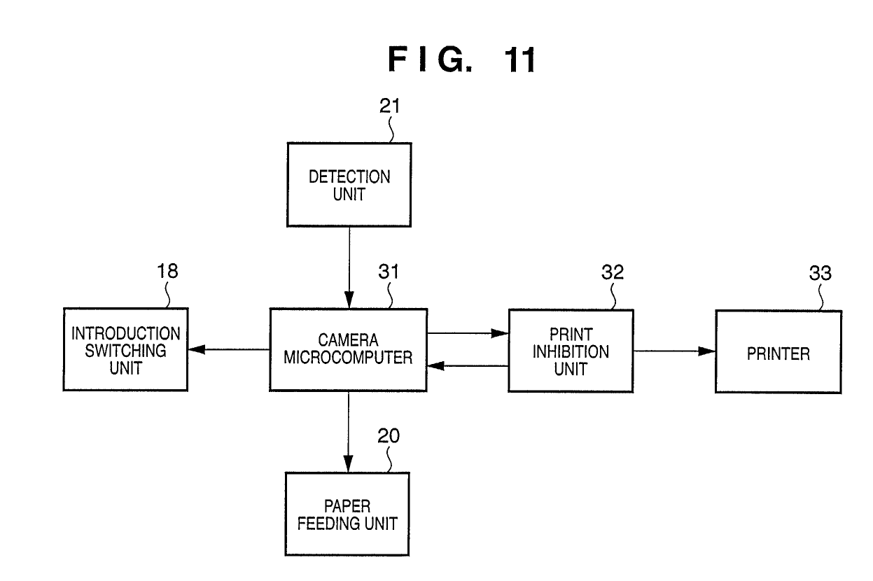

FIG. 9 is a cross-sectional view of the printer built-in camera according to the third embodiment of the present invention. FIG. 10 is a cross-sectional view of the print sheet storage unit attachable/detachable to/from the printer built-in camera in FIG. 9. FIG. 11 is a block diagram showing the construction of the printer built-in camera according to the third embodiment.

As shown in FIG. 11, in the printer built-in camera according to the third embodiment of the present invention, the camera main body 1 has a paper feeding unit 20 which is used upon discharge/storage of print sheet, a detection unit 21 which detects a printed sheet by electromagnetic detection, optical detection or the like, a camera microcomputer 31 which controls the respective elements of the camera main body 1 (the paper feeding unit 20, the detection unit 21, a print inhibition unit 32 and the like), the print inhibition unit 32 which controls print inhibition, and a printer 33 which discharges ink from the user side toward the subject side.

As shown in FIG. 10, a print sheet storage unit 22 inserted into the camera main body 1 has a storage unit 23 in which a print sheet is stored, the discharge/storage port 15, the operation unit 8 (not shown) and the introduction switching unit 18. The storage unit 23 does not have an inner wall partitioning a part for storing unused print sheets from a part for storing printed sheets, however, these print sheets are separately stored by the introduction switching unit 18. The printed sheet is stored in the rearmost of print sheets in the storage unit 23 (on the user side in the storage unit 23) by the introduction switching unit 18. The introduction switching unit 18 is controlled by the camera microcomputer 31.

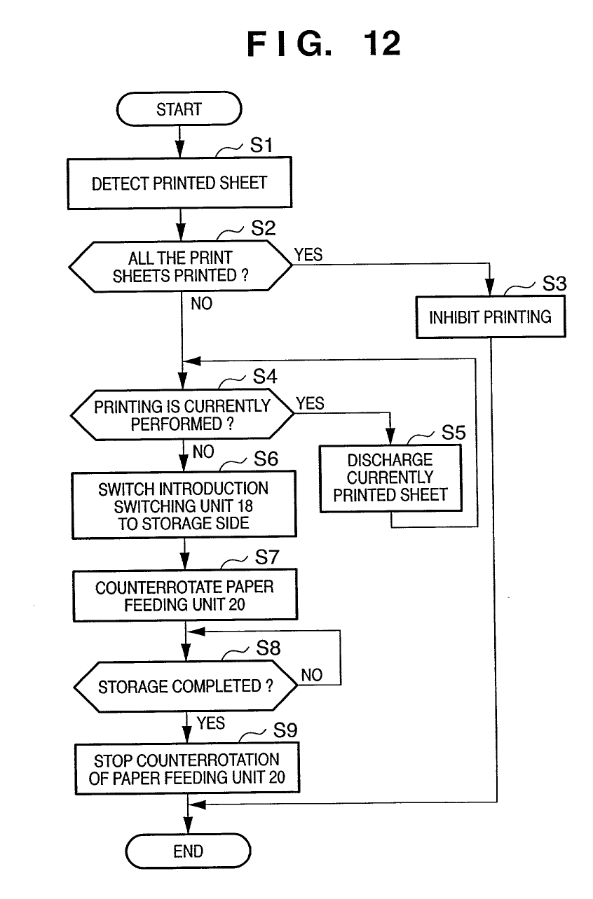

FIG. 12 is a flowchart showing printed sheet storing processing. The processing is started when the main power of the camera main body 1 is turned on and an image print mode is set.

First, the detection unit 21 detects a printed sheet (step S1), and the camera microcomputer 31 determines whether or not all the print sheets in the storage unit 23 have been printed (step S2).

If it is determined from the result of the determination at step S2 that all the print sheets in the storage unit 23 have been printed, the print inhibition unit 32 inhibits printing by the printer 33 (step S3), and the process ends. By this processing, the user's unexpected overlap printing can be prevented.

On the other hand, if it is determined from the result of the determination at step S2 that an unused print sheet exists in the storage unit 23, the camera microcomputer 31 determines whether or not the printing is currently performed (step S4). If the printing is currently performed, the paper feeding unit 20 is rotated to discharge the currently printed sheet (step S5), and the determination at step S4 is repeated. Note that at step S5, the currently printed sheet is not completely discharged to the outside the camera main body 1.

If it is determined from the result of determination at step S4 that the printing is not currently performed, i.e., the printing has been completed, the introduction switching unit 18 is switched to the storage side (the subject side in the storage unit 23) (step S6), and the paper feeding unit 20 is counterrotated (step S7) to store the print sheet discharged at step S5 into the storage unit 23.

Next, it is determined whether or not the storage of the print sheet discharged at step S5 has been completed (step S8), and if it is determined that the storage has been completed, the rotation of the paper feeding unit 20 is stopped (step S9), and the process ends.

As described above, according to the present embodiment, the detection unit 21 detects a printed sheet, and if all the print sheets in the storage unit 23 have been printed, the print inhibition unit 32 inhibits printing by the printer 33, thereby printing failure due to overlapped printing can be prevented.

Further, if printing is currently performed, the camera microcomputer 31 controls the paper feeding unit 20 to discharge a currently printed sheet, while if the printing has been completed, the camera microcomputer 31 controls the paper feeding unit 20 to store the discharged print sheet into the storage unit 23. Accordingly, the printed sheet can be automatically stored into the storage means.

At the above-described step S1, the detection unit 21 detects a printed sheet, however, the printed sheet may be detected by using the amount or time of rotation of motor used in the paper feeding unit 20.

Note that the introduction switching unit 18 is controlled by the camera microcomputer 31, however, it may be arranged such that the introduction switching unit 18 is stressed by an elastic body such as a spring so as to trap an unused print sheet in the storage unit 23.

Further, in the print sheet storage unit 22, unused print sheets and printed sheets are stored in one storage unit 23, however, the unused and printed sheets may be separately stored into two storage units as in the case of the print sheet storage unit 12 used in the first and second embodiments.

The construction of the printer built-in camera of the present invention is not limited to the first to third embodiments. For example, the direction of ink discharge and/or the positions of the unused sheet storage unit 4 and the printed sheet storage unit 7 may be reversed. Further, the print sheet storage units 2 and 12 have the unused sheet storage unit 4 and the printed sheet storage unit 7, however, the print sheet storage units 2 and 12 may further have another storage unit.

Further, in the above embodiments, the printer is integrated with the image sensing apparatus, however, the present invention is applicable to a case where the printer and image sensing apparatus are separately provided.

Further, the above embodiments or technical elements thereof may be combined in accordance with necessity.

As described in detail above, according to the embodiments, as the printer built-in camera has the print sheet storage means for storing unused print sheets and for storing printed sheets, the printed sheet can be protected, and the portability of printed sheet can be improved. Thus the usability can be improved.

Further, as the print sheet storage means is removable, when only image sensing is performed, the print sheet storage means can be removed from the printer built-in camera. In this case, the camera can be downsized.

Further, as the printer built-in camera has the take out means for taking out stored printed sheets, the printed sheet can be taken out in accordance with the user's necessity.

Further, as the printer built-in camera has the open window through which an image on a printed sheet is checked, the image on the printed sheet can be easily checked.

Further, printed sheets can be stored into the print sheet storage means in cooperation with an image sensing lens storing operation by the image sensing lens storage means.

Further, an image on a printed sheet can be easily checked.

Further, as the printer is controlled based on the result of detection by the detection means not to perform reprinting on a printed sheet stored in the print sheet storage means, printing failure due to overlapped printing can be prevented.

Further, a printed sheet can be automatically stored into the print sheet storage means.

The present invention is not limited to the above embodiments and various changes and modifications can be made within the spirit and scope of the present invention. Therefore, to appraise the public of the scope of the present invention, the following claims are made.

What is claimed is:

1. A printer used in combination with an image sensing apparatus including:
a printing unit that prints an image obtained by said image sensing apparatus on a print sheet; and
a storage unit, connected to said printing unit, that holds unused print sheets supplied to said printing unit and printed sheets printed by said printing unit.

2. The printer according to claim 1, wherein said printing unit is integrally provided with said image sensing apparatus.

3. The printer according to claim 2, wherein said storage unit is attachable/detachable to/from said printing unit.

4. The printer according to claim 1, wherein said storage unit is attachable/detachable to/from said printing unit.

5. The printer according to claim 1, wherein said storage unit has a window that enables a check of said printed sheet stored in said storage unit.

6. The printer according to claim 1, wherein said storage unit has a window that enables a check of an image printed on said printed sheet stored in said storage unit.

7. The printer according to claim 1, further including a cover that covers an image sensing optical system, wherein said printed sheet is stored into said storage unit in cooperation with an operation of said cover to cover the image sensing optical system.

8. The printer according to claim 1, wherein said printing unit includes a print sheet feeding device that pulls out said unused print sheet from said storage unit for printing and returns said printed sheet into said storage unit.

9. The printer according to claim 1, wherein said storage unit includes a partitioning device which separates said unused print sheet from said printed sheet thereby preventing mixing of said unused print sheet with said printed sheet.

10. A printer including:
a printing unit that performs printing on a print sheet; and
a storage unit, connected to said printing unit, that holds unused print sheets supplied to said printing unit and printed sheets printed by said printing unit.

11. The printer according to claim 10, wherein said storage unit is attachable/detachable to/from said printing unit.

12. The printer according to claim 10, wherein said storage unit has a window that enables a check of said printed sheet stored in said storage unit.

13. The printer according to claim 10, wherein said storage unit has a window that enables a check of an image printed on said printed sheet stored in said storage unit.

14. The printer according to claim 10, further including a cover that covers an image sensing optical system, wherein said printed sheet is stored into said storage unit in cooperation with an operation of said cover to cover the image sensing optical system.

15. The printer according to claim 10, wherein said printing unit includes a print sheet feeding device that pulls out said unused print sheet from said storage unit for printing and returns said printed sheet into said storage unit.

16. The printer according to claim 10, wherein said storage unit includes a partitioning device which separates said unused print sheet from said printed sheet thereby preventing mixing of said unused print sheet with said printed sheet.

17. A printer adapter attachable/detachable to/from a printer which is used in combination with an image sensing apparatus and which prints an image obtained by said image sensing apparatus on a print sheet, wherein said adapter including:
a storage unit that holds unused print sheets supplied to said printer and printed sheets printed by said printer.

18. The printer adapter according to claim 17, wherein said adapter has a window that enables a check of said printed sheet stored in said storage unit.

19. The printer adapter according to claim 17, wherein said adapter has a window that enables a check of an image printed on said printed sheet stored in said storage unit.

20. The printer adapter according to claim 17, wherein said adapter includes a partitioning device which separates said unused print sheet from said printed sheet thereby preventing mixing of said unused print sheet with said printed sheet.

21. A printer adapter attachable/detachable to/from a printer which performs printing on a print sheet including:
a storage unit that holds unused print sheets supplied to said printer and printed sheets printed by said printer.

22. The printer adapter according to claim 21, wherein said adapter has a window that enables a check of said printed sheet stored in said storage unit.

23. The printer adapter according to claim 21, wherein said adapter has a window that enables a check of an image printed on said printed sheet stored in said storage unit.

24. The printer adapter according to claim 21, wherein said adapter includes a partitioning device which separates said unused print sheet from said printed sheet thereby preventing mixing of said unused print sheet with said printed sheet.
